(19) United States
(12) Patent Application Publication
(10) Pub. No.: US 2009/0277731 A1
(43) Pub. Date: Nov. 12, 2009

(54) BRAKE DRUM FOR VEHICLE AND METHOD OF MANUFACTURING THE SAME

(75) Inventor: Jin Ha Hwang, Goyang-Si (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/326,367

(22) Filed: Dec. 2, 2008

(30) Foreign Application Priority Data
May 8, 2008 (KR) 10-2008-0042794

(51) Int. Cl. F16D 65/10; B29C 55/00

(52) U.S. Cl. 188/218 R; 264/129

(57) ABSTRACT

Disclosed herein is a composition for a vehicle brake drum, including 3.2˜4.2 wt % of carbon, 1.5˜2.8 wt % of silicon, 0.6˜0.9 wt % of manganese, 0.1 wt % or less of sulfur, 0.1˜0.3 wt % of chromium, 0.2˜0.5 wt % of molybdenum, 5˜10 wt % of carbon nanotubes, and a balance of cast iron. The vehicle brake drum is thermally coated with carbon nanotubes. The vehicle brake drum has excellent wear resistance and provides stable braking force.

### CROSS-REFERENCE TO RELATED APPLICATIONS

This application claims under 35 U.S.C. §119(a) priority to Korean Application No. 10-2008-0042794, filed on May 8, 2008, the disclosure of which is incorporated herein by reference in its entirety.

### BACKGROUND

1. Technical Field

The present invention relates to a vehicle brake drum having excellent wear resistance and providing stable braking force, and a method of manufacturing the same.

2. Related Art

A drum brake system serves to stop a vehicle by bringing brake shoes, also referred to as brake linings, into contact with the inner circumferential surface of a brake drum, which rotates together with the wheels, using the hydraulic pressure of a wheel cylinder. The drum brake system chiefly includes a brake drum, a back plate, brake shoes, a wheel cylinder, a screw for adjusting a gap, a return spring, a parking brake strut, and the like.

The brake drum is provided on a driving shaft or a wheel spindle together with a wheel. Therefore, the brake drum is configured such that it rotates together with the wheel when the wheel rotates. The back plate is provided therein with brakes shoes and other expansion parts. Further, the brake plate is provided and fitted on an axle housing. That is, the brake shoes are provided in the back plate such that they can be expanded, but cannot be rotated.

When a brake pedal is pushed, the brake shoes are pressed onto the inner circumferential surface of the brake drum by an expansion apparatus, such as a brake shoe actuation pin or a cam. In this case, the frictional force necessary for braking is generated through brake lining attached to the brake shoes. Further, the force necessary for expanding the brake shoes is generated from the hydraulic pressure of the wheel cylinder in a main brake, and is generated by a cable or lever in a parking brake.

The brake drum is provided on a wheel hub assembly using a bolt, and serves to generate braking force using the friction between the brake drum and the brake shoes while rotating together with the wheels. The brake drum requires the following conditions: 1) the brake drum must be in static or dynamic equilibrium, 2) the brake drum must be strong enough not to be deformed when the brake shoes are expanded, 3) the frictional surface between the brake drum and the brake shoes must have sufficient wear resistance, 4) the brake drum must radiate heat well, and 5) the brake drum must be light.

As raw materials of the brake drum, cast iron, steel, aluminum (Al), and the like may be used. Among the raw materials, cast iron is hard, but is easily broken because it is very brittle. In addition, cast iron resists wear, resists twisting, and is highly resistant to large amounts of heat. These days, in most vehicles, a brake drum including a rim made of cast iron and a hub made of steel is used. Such cast iron includes carbon, chromium, magnesium, silicon, phosphorus, and the like.

In order to improve the radiation performance of a brake drum, there is a brake drum provided with fins in a direction perpendicular to the circumference thereof. In particular, aluminum functions to improve the heat transfer on the frictional surface. There is a brake drum provided with a high-tension spring around the outer surface thereof, the high-tension spring serving to reduce the vibration of the brake drum at the time of operation of a brake system. Methods of mounting a brake drum may include rear-drive axle flange mounting, rear wheel hub mounting (front wheel drive vehicles), and front wheel hub mounting (rear wheel drive vehicles).

The hottest portion of a brake drum is the frictional surface. Since this frictional surface is not exposed to the atmosphere, as it is in a disc brake, it is not easily cooled. Since a brake drum is expanded when it is overheated, the distance between the brake shoes and the brake drum is increased, thus increasing brake pedal travel. When a brake is rapidly operated under extreme conditions, the brake drum is distorted or becomes elliptical due to heat. The reason for this is that the pressure applied from the brake shoes in the outward direction is not uniformly distributed in the brake drum. When the brake drum, changed to be elliptical, is cooled, the elliptical shape is maintained. This phenomenon causes a pedal to vibrate and decreases braking efficiency. Further, the overheating of the brake drum causes bell mouth, which is a phenomenon in which the outer diameter becomes greater than the inner diameter, hard spot, check, crack, and the like.

The above information disclosed in this Background section is only for enhancement of understanding of the background of the invention and therefore it may contain information that does not form the prior art that is already known in this country to a person of ordinary skill in the art.

### SUMMARY

Accordingly, the present invention has been made keeping in mind the above problems occurring in the prior art, and an object of the present invention is to provide a vehicle brake drum which can exhibit excellent wear resistance and provide stable braking force even after a vehicle has been operated for a long time, and a method of manufacturing the same.

In order to accomplish the above object, an aspect of the present invention provides a vehicle brake drum having a composition including 3.2˜4.2 wt % of carbon, 1.5˜2.8 wt % of silicon, 0.6˜0.9 wt % of manganese, 0.1 wt % or less of sulfur, 0.1˜0.3 wt % of chromium, 0.2˜0.5 wt % of molybdenum, 5˜10 wt % of carbon nanotubes, and a balance of cast iron.

Preferably, carbon nanotubes are coated on the surface of the vehicle brake drum such that the amount of the carbon nanotubes is 1˜5% based on the total weight of the vehicle brake drum.

Another aspect of the present invention provides a method of manufacturing a vehicle brake drum, comprising: mixing 3.2˜4.2 wt % of carbon, 1.5˜2.8 wt % of silicon; 0.6˜0.9 wt % of manganese, 0.1 wt % or less of sulfur, 0.1˜0.3 wt % of chromium, 0.2˜0.5 wt % of molybdenum, 5˜10 wt % of carbon nanotubes, and a balance of cast iron to form a mixture; and thermoforming the mixture in a brake drum shape to prepare a molded product.

The method of manufacturing a vehicle brake drum further comprises: coating carbon nanotubes on the molded product using thermal spray technique; and heat-treating the molded product coated with the carbon nanotubes.

In the method, it is preferred that the carbon nanotubes are sprayed onto the molded product such that an amount of the carbon nanotubes is 1˜5% based on the total weight of the molded product.

Also, it is preferred that the thermoforming of the mixture be conducted at an initial temperature of 130˜160° C. and a pressure of 100˜160 kg/cm², and that the heat-treating of the molded product coated with the carbon nanotubes be conducted at a temperature of 130˜160° C.

Meanwhile, it can be understood that the vehicle brake drum according to the present invention may be manufactured using commonly-used melt casting methods.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### DETAILED DESCRIPTION

Hereinafter, preferred embodiments of the present invention will be described in detail.

As discussed above, one aspect of the present invention provides a composition for a vehicle brake drum. The composition includes 3.2˜4.2 wt % of carbon. When the amount of carbon is less than 3.2 wt %, it is difficult to improve wear resistance and crack-proofness. When the amount of carbon is more than 4.2 wt %, an excess amount of graphite is abnormally formed, thus increasing casting defects. Therefore, the amount of carbon is controlled in a range of 3.2˜4.2 wt %.

The composition includes silicon in an amount of 1.5˜2.8 wt %. Silicon serves to prevent a matrix from being formed into white pig iron and to prevent ferrite from being excessively precipitated.

The composition includes manganese in an amount of 0.6˜0.9 wt %. Manganese serves to accelerate the formation of a matrix into pearlite, and contributes to the improvement of wear resistance by reinforcing a matrix.

The composition includes sulfur in am amount of 0.1 wt % or less (including 0 wt %). Since Sulfur incurs brittle fracture problem, the sulfur content should be minimized.

The composition includes molybdenum in an amount of 0.2˜0.5 wt %. Molybdenum serves to improve hot strength. When the amount of molybdenum is less than 0.2 wt %, hot strength cannot be sufficiently improved. When the amount of molybdenum is more than 0.5 wt %, a segregation phenomenon occurs in a cell boundary of a matrix.

The composition includes 0.1˜0.3 wt % of chromium. When the amount of chromium is 0.1 wt % or more, more preferably 0.15 wt or more, chromium serves to prevent graphitization and improve hardiness, heat-resisting property and corrosion resistance by generating fine pearlite structure. However, when the amount of chromium is more than 0.3 wt %, very brittle phase such as ledeburite and carbide composites are formed.

The composition further includes 5˜10 wt % of carbon nanotubes. The reason will be described below.

The composition of the vehicle brake drum is shown in Table 1 below.

TABLE 1

| Constituents | wt % |
|---|---|
| Carbon | 3.2~4.2 |
| Silicon | 1.5~2.8 |
| Manganese | 0.6~0.9 |
| Sulfur | 0.1 or less |
| Chromium | 0.1~0.3 |
| Molybdenum | 0.2~0.5 |
| Carbon nanotube | 5~10 |
| Cast iron | a balance |

Another aspect of the present invention provides a method of manufacturing a vehicle brake drum. The vehicle brake drum can be manufactured as follows. The powders of the above-described components are uniformly mixed to form a mixture. The mixture is thermoformed in a brake drum shape at a temperature of 130˜160° C. and a pressure of 100˜160 kg/cm². Carbon nanotubes of 1˜5% based on the total weight of the thermoformed mixture are coated on the molded product using thermal spray technique. The molded product is then heat-treated at a temperature of 130˜160° C.

In this case, when the amount of the carbon nanotubes is below 1%, an extremely small amount of carbon nanotubes is sprayed onto the molded product, thus exhibiting no thermal spray coating effect. On the other hand, carbon nanotubes of more than 5% does not particularly improve the performance of the vehicle brake drum. The thermal spray coating of carbon nanotubes improves anti-wear property of the molded product up to about 5%.

In the above process, when carbon nanotubes are adhered to a base material, additional mechanical strength and frictional characteristics are imparted to the vehicle brake drum.

Since carbon nanotubes have very small particle sizes, and in contrast, cast iron has a relatively large surface area, carbon nanotube particles are easily adhered to the base material. Further, since the particle size of carbon nanotubes is very small compared to that of cast iron present in the base material, carbon nanotube particles are very uniformly dispersed in the entire base material.

Furthermore, carbon nanotube particles serve to manufacture a high-performance vehicle brake drum and to form a porous base material having high transmissivity. The high transmissivity of the base material including carbon nanotube particles enables fluid to suitably flow in a vehicle brake drum, prevent a shuddering phenomenon, and cause the vehicle brake drum to include a suitable amount of fluid.

Meanwhile, a thermal spray coating method, which is a method of forming a rapidly-solidified layer by melting powder or linear materials using a high-temperature heat source (changing powder or linear materials into melted droplets using a high-temperature heat source) and then colliding the melted powder or linear material on a base material, requires a heat source, such as flame, arc or plasma, having high energy density, in order to heat and melt raw materials. Through this thermal spray coating method, a thick carbon nanotube layer can be formed on the surface of the vehicle brake drum. The carbon nanotube layer formed in this way serves to prevent the deformation of the vehicle brake drum and the change of material properties of the vehicle brake drum, and enables the vehicle brake drum to maintain excellent wear resistance even after the vehicle brake drum has been used for a long time.

### EXAMPLES

The following examples illustrate the invention and are not intended to limit the same.

Vehicle brake drums were prepared by the above-described methods with the following components shown in Table 2.

TABLE 2

| | | | | | | | Carbon |
|---|---|---|---|---|---|---|---|
| Class. | Carbon | Silicon | Manganese | Sulfur | Chromium | Molybdenum | Nanotube |
| Example 1 | 4.0 | 2.5 | 0.6 | 0.1 | 0.3 | 0.2 | 10 |
| Example 2 | 4.0 | 2.0 | 0.9 | 0.1 | 0.2 | 0.4 | 5 |
| Comp. | 4.0 | 2.5 | 0.6 | 0.1 | 0.3 | 0.5 | — |
| Example 1 | | | | | | | |
| Comp. | 4.0 | 2.5 | 0.6 | 0.1 | 0.3 | 0.4 | — |
| Example 2 | | | | | | | |

Performance test of the vehicle brake drums prepared in Examples 1 and 2 and Comparative Examples 1 and 2 was conducted. As given in Table 3, the performance test was conducted by measuring the radiation performance and wear amount thereof while changing braking velocity, deceleration, brake temperature and number of braking actions.

TABLE 3

| | | | Number of |
|---|---|---|---|
| Braking | | Brake | Braking |
| velocity | Deceleration | temperature | Actions |
| 80→ 0 KPH | 0.4 g(T) | FR: 80° C. | 300/1,000 |
| 50→ 0 KPH | 0.25 g(T) | FR: 200° C. | 4,000 |
| | | FR: 200° C. | |
| | | RR: 100° C. | |
| 50→ 10 KPH | 0.2 g(T) | FR: 180° C. | 1,600 |
| | | FR: 180° C. | |
| | | RR: 100° C. | |

In Table 3, FR is a front right wheel, and RR is a rear right wheel. For reference, in the decreasing braking velocity of 80→0 KPH, the braking test was conducted 300 times for a complete pad (newly prepared) and 1000 times for a pad cut to ½ of its original thickness in order to simulate real field conditions. Both tests showed the same results. For example, after the deceleration was completed, the temperature of the pad of FR was 80° C.

The results of measurement of the radiation performances and wear amounts of the vehicle brake drums in Examples 1 and 2 and Comparative Examples 1 and 2 are given in Table 4. Here, the radiation performance is defined as the time taken for the vehicle brake drum to cool to a temperature of 20° C. after braking.

TABLE 4

| | | | Comp. | Comp. |
|---|---|---|---|---|
| Class. | Example 1 | Example 2 | Example 1 | Example 2 |
| Radiation | 421 | 432 | 564 | 577 |
| performance | | | | |
| (sec) | | | | |
| wear | 2.512 | 2.754 | 4.252 | 4.684 |
| amount | | | | |
| (mm) | | | | |

From Table 4, it can be seen that the radiation performances of the vehicle brake drums in Examples 1 and 2 were improved by about 25% or more compared to the vehicle brake drums in Comparative Examples 1 and 2, and the wear amounts of the vehicle brake drums in Examples 1 and 2 were decreased by about 45% or more compared to the vehicle brake drums in Comparative Examples 1 and 2. That is, it can be seen that the mechanical properties of the manufactured vehicle brake drums are considerably improved according to the present invention.

As described above, according to the present invention, a vehicle brake drum, which can exhibit excellent wear resistance and provide stable braking force even after a vehicle has been operated for a long time, can be obtained.

Further, according to the present invention, physical properties of the vehicle brake drum are remarkably improved, including a high thermal conductivity, a low thermal expansion coefficient, a high melting point, low density, a high thermal capacity, high wear resistance and high heat resistance, which allows the brake drum to maintain its strength and hardness over a wide temperature range, compared to conventional vehicle brake drums.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vehicle brake drum having a composition comprising:
3.2˜4.2 wt % of carbon;
1.5˜2.8 wt % of silicon;
0.6˜0.9 wt % of manganese;
0.1 wt % or less of sulfur;
0.1˜0.3 wt % of chromium;
0.2˜0.5 wt % of molybdenum;
5˜10 wt % of carbon nanotubes; and
a balance of cast iron.

2. The vehicle brake drum according to claim 1, wherein the vehicle brake drum further comprises a coating of carbon nanotubes sprayed on a surface of the vehicle brake drum, the coating comprising carbon nanotubes in an amount of 1˜5wt % based on a total weight of the vehicle brake drum.

3. A method of manufacturing a vehicle brake drum, comprising:
mixing 3.2˜4.2 wt % of carbon, 1.5˜2.8 wt % of silicon; 0.6˜0.9 wt % of manganese, 0.1 wt % or less of sulfur, 0.1˜0.3 wt % of chromium, 0.2˜0.5 wt % of molybdenum, 5˜10 wt % of carbon nanotubes, and a balance of cast iron to form a mixture; and
thermoforming the mixture to prepare a molded product.

4. The method of manufacturing a vehicle brake drum according to claim 3, further comprising:
coating carbon nanotubes on the molded product using thermal spray technique; and
heat-treating the molded product coated with the carbon nanotubes.

5. The method of manufacturing a vehicle brake drum according to claim 4, wherein the carbon nanotubes are sprayed onto the molded product in an amount of 1˜5wt % based on the total weight of the molded product.

6. The method of manufacturing a vehicle brake drum according to claim 3, wherein the thermoforming of the mixture is conducted at an initial temperature of 130˜160° C. and a pressure of 100˜160 kg/cm².

7. The method of manufacturing a vehicle brake drum according to claim 4, wherein the heat-treating of the molded product is conducted at a temperature of 130˜160° C.
